(19) United States
(12) Patent Application Publication
(10) Pub. No.: US 2013/0056431 A1
(43) Pub. Date: Mar. 7, 2013

(54) Tool-Displaying Apparatus

(71) Applicant: Da-Sen LIN, Taichung City (TW)

(72) Inventor: Da-Sen LIN, Taichung City (TW)

(21) Appl. No.: 13/227,468

(22) Filed: Sep. 7, 2011

(51) Int. Cl. A47F 1/04; B60B 33/00; A47F 7/00

(52) U.S. Cl. 211/59.2; 211/70.6; 211/85.8

(57) ABSTRACT

A tool-displaying apparatus includes a base, a tray and at least one linkage. The tray is connected to the base so that the tray can be pivoted relative to the base between a flat position and a fully pivoted position. The linkage is used to keep the tray in the fully pivoted position relative to the base.

### BACKGROUND OF INVENTION

1. Field of Invention

The present invention relates to tools and, more particularly, to an apparatus for displaying tools.

2. Related Prior Art

As disclosed in U.S. Pat. No. 7,699,413 and Taiwanese Patent Publication No. 554811, a tool cart includes a cabinet supported on casters so that the tool cart can be moved around. The cabinet includes several drawers movably supported thereon. These drawers are square and define identical spaces for receiving various tools. It is however impossible to know what tools are stored in which drawer. The drawers have to be opened so that the tools contained therein can be seen and a needed tool can be taken from the related drawer for use. This is a waste of time and exhausting.

The present invention is therefore intended to obviate or at least alleviate the problems encountered in prior art.

### SUMMARY OF INVENTION

It is an objective of the present invention to provide an apparatus for displaying tools.

To achieve the foregoing objectives, the tool-displaying apparatus includes a base, a tray and at least one linkage. The tray is connected to the base so that the tray can be pivoted relative to the base between a flat position and a fully pivoted position. The linkage is used to keep the tray in the fully pivoted position relative to the base.

In an aspect, the linkage includes two levers. The first lever is secured to the tray. The second lever includes a first end pivotally connected to the base and a second end movably connected to the first lever.

In another aspect, the linkage further includes a sliding element. The first lever includes a slot for movably receiving the sliding element.

In another aspect, the first lever further includes a cutout defined in an edge of the slot. The sliding element is retained in the cutout to keep the tray in the fully pivoted position.

In another aspect, linkage includes a receptacle and a lever. The receptacle is attached to the tray. The lever includes an end pivotally connected to the base and another end for insertion in the receptacle, thus retaining the tray in the fully pivoted position relative to the base.

In another aspect, the linkage includes a stop and a lever. The stop is attached to the base. The lever includes an end pivotally connected to the tray and another end for abutment against the stop, thus retaining the tray in the fully pivoted position relative to the base.

It is another objective of the present invention to provide a multi-layered apparatus for displaying tools.

To achieve the foregoing objective, the tool-displaying apparatus includes posts and at least two layers. Each of the layers includes a base, a tray and a linkage. The base is supported on the posts. The tray is connected to the base so that the tray can be pivoted between a flat position and a fully pivoted position relative to the base. The linkage is used to support the tray in the fully pivoted position relative to the base.

In an aspect, the base of the upper layer is movably supported on the posts.

In another aspect, the tray of the lower layer is movably and pivotally connected to the base of the upper layer.

In another aspect, the tool-displaying apparatus further includes two sliding elements attached to the tray of the lower layer. The base of the upper layer includes two slots for movably receiving the sliding elements.

In another aspect, the posts are telescopic posts.

Other objectives, advantages and features of the present invention will be apparent from the following description with reference to the attached drawings.

### BRIEF DESCRIPTION OF DRAWINGS

The present invention will be described via detailed illustration of four embodiments with reference to the drawings wherein:

FIG. 1 is a perspective view of a tool-displaying apparatus in accordance with the first embodiment of the present invention;

FIG. 2 is a side view of the tool-displaying apparatus shown in FIG. 1;

FIG. 3 is a perspective view of a linkage used in the tool-displaying apparatus shown in FIG. 1;

FIG. 4 is a perspective view of the linkage in another position than shown in FIG. 3;

FIG. 5 is a perspective view of a tool-displaying apparatus in accordance with the second embodiment of the present invention;

FIG. 6 is a side view of the tool-displaying apparatus shown in FIG. 5;

FIG. 7 is a side view of a tool-displaying apparatus in accordance with the third embodiment of the present invention;

FIG. 8 is an exploded view of a tool-displaying apparatus in accordance with the fourth embodiment of the present invention;

FIG. 9 is a perspective view of the tool-displaying apparatus of FIG. 8;

FIG. 10 is a side view of the tool-displaying apparatus in another position than shown in FIG. 9;

FIG. 11 is a cross-sectional view of a spring-biased detent unit used in the tool-displaying apparatus taken along a line A-A shown in FIG. 10;

FIG. 12 is a side view of the tool-displaying apparatus in another position than shown in FIG. 10;

FIG. 13 is a cross-sectional view of another spring-biased detent unit used in the tool-displaying apparatus taken along a line B-B shown in FIG. 12;

FIG. 14 is a perspective view of the tool-displaying apparatus in another position than shown in FIG. 9; and

FIG. 15 is a partial, side view of the tool-displaying apparatus shown in FIG. 14.

### DETAILED DESCRIPTION OF EMBODIMENTS

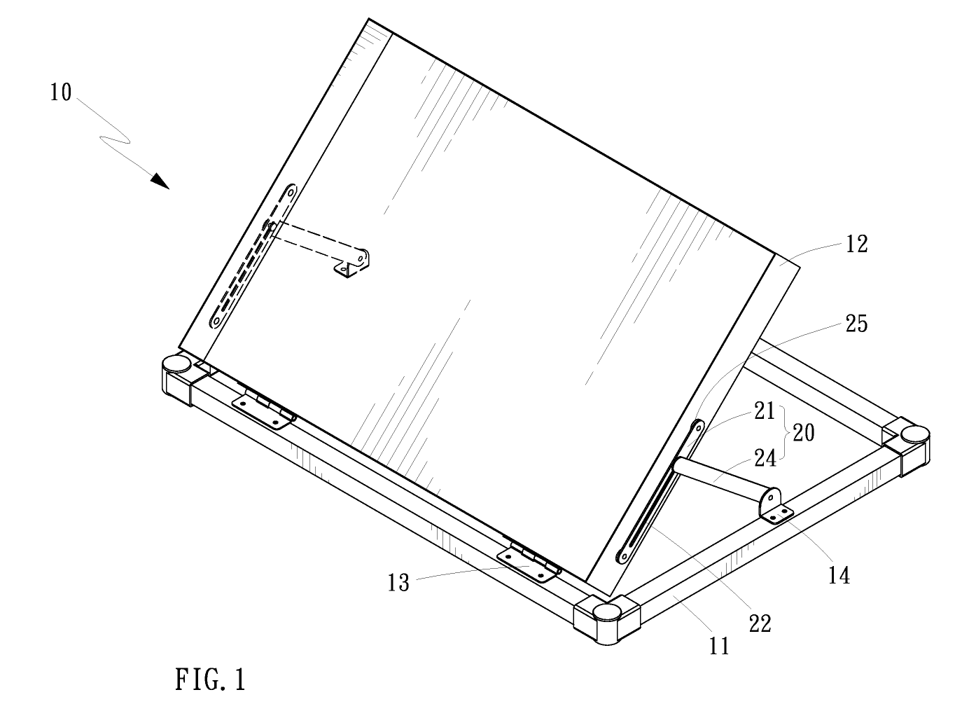

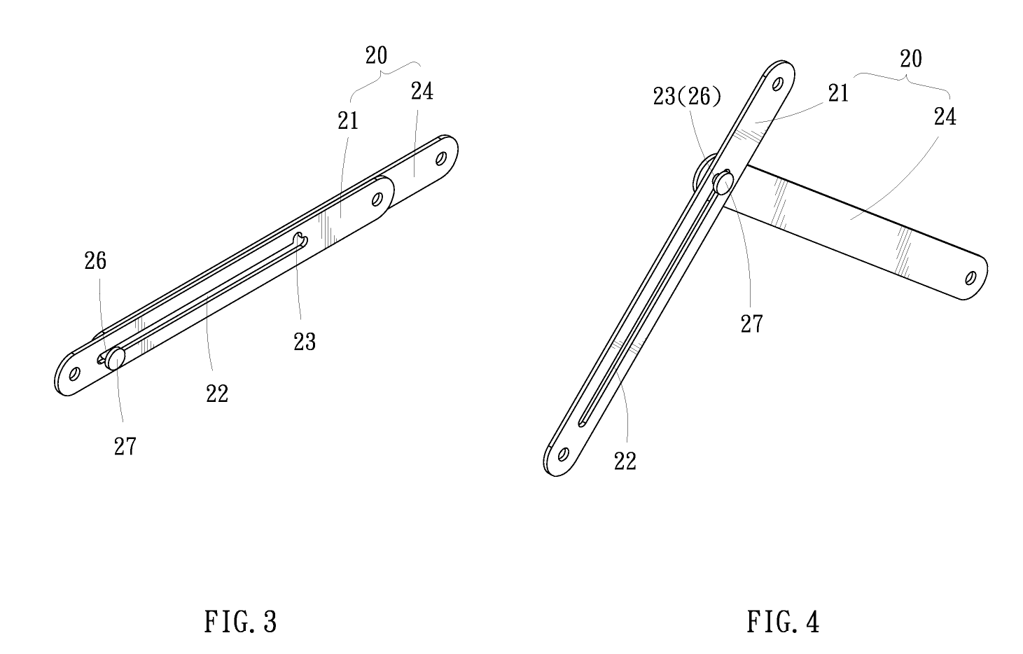

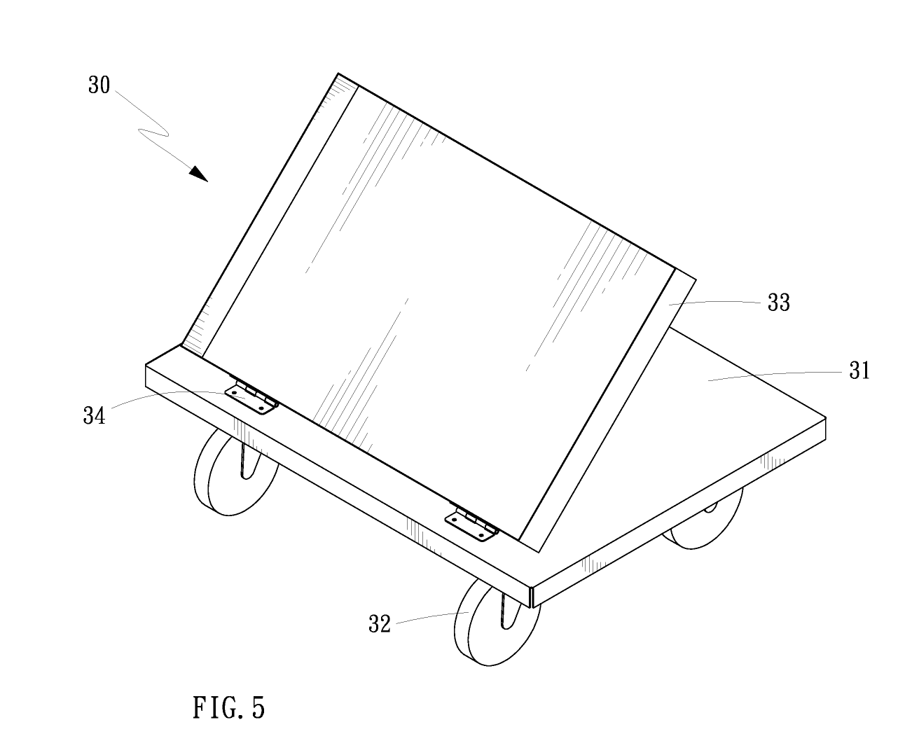

With reference to FIGS. 1 through 4, there is shown a tool-displaying apparatus 10 in accordance with a first embodiment of the present invention. The tool-displaying apparatus 10 includes a base 11, a tray 12, two hinges 13 and two identical linkages 20. The base 11 is shaped like a frame for use to support a photograph. That is, the base 11 includes two left and right bars extending between front and rear bars.

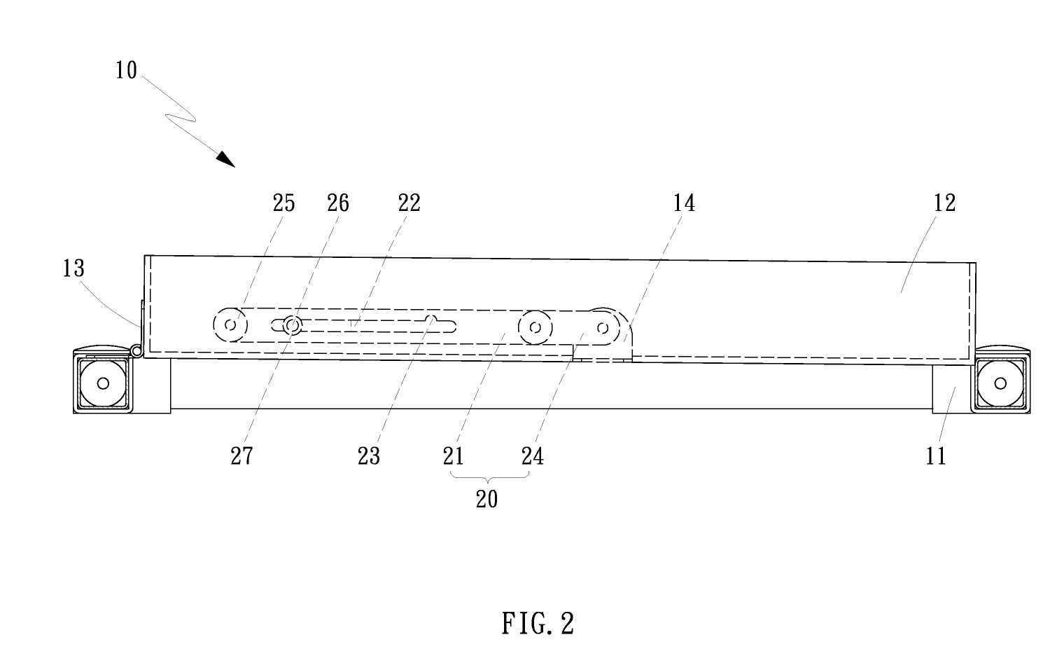

The tray 12 may simply be a plate made with a planar upper face. However, the tray 12 may include cavities defined in the upper face for receiving tools. A front edge of the tray 12 is pivotally connected to the front bar of the base 11 by the hinges 13. The size of the tray 12 is marginally smaller than that of a space defined by the base 11 so that the tray 12 is located in the space defined by the base 11 when the tray 12 is located laid down as shown in FIG. 2.

Each of the linkages 20 includes a bracket 14, two levers 21 and 24, two washers 25 and a sliding element. The bracket 14 is an L-shaped element with two sections extending perpendicular to each other.

The lever 21 is preferably a metal strip with a slot 22 longitudinally defined therein and a cutout 23 transversely defined therein. In detail, the slot 22 is defined between upper and lower edges, and the cutout 23 is defined in the upper edge of the slot 22.

The lever 24 is preferably a metal strip. The sliding element includes a head 27 formed on a body 26. The diameter of the body 26 of the sliding element is marginally smaller than the width of the slot 22. The diameter of the head 27 of the sliding element is considerably larger than the width of the slot 22. The thickness of the head 27 is marginally smaller than the thickness of the washers 25.

In assembly, the first section of the bracket 14 is secured to the right or left bar of the base 11 by screws, pins or rivets for example. A rear end of the lever 24 is pivotally connected to the second section of the bracket 14 by a screw, pin or rivet for example. The body 26 of the sliding element is inserted through the slot 22 before the sliding element is connected to a front end of the lever 24 by a screw, pin or rivet for example. Thus, the lever 21 is restrained between the head 27 of the sliding element and the lever 24. Accordingly, the lever 21 is connected to the lever 24 by the sliding element. The washers 25 are located between a left or right edge of the tray 12 and the lever 21 before two screws, pins or rivets are driven into the left or right edge of the tray 12 through the washers 25 and front and rear ends of the lever 21.

In use, the tray 12 can be laid down relative to the base 11 as shown in FIG. 1 or raised relative to the base 11 as shown in FIG. 2. As the tray 12 is moved relative to the base 11 between the positions shown in FIGS. 1 and 2, the lever 21 is pivoted together with the tray 12 and the lever 24 is pivoted relative to the base 11 while the body 26 of the sliding element is moved along the slot 22 defined in the lever 21. As shown in FIG. 1, the tray 12 is located in the space defined by the base 11 as the tray 12 is laid down relative to the base 11. As shown in FIG. 2, the tray 12 is kept raised relative to the base 11 as the body 26 of the sliding element is located in the cutout 23 defined in the lever 21.

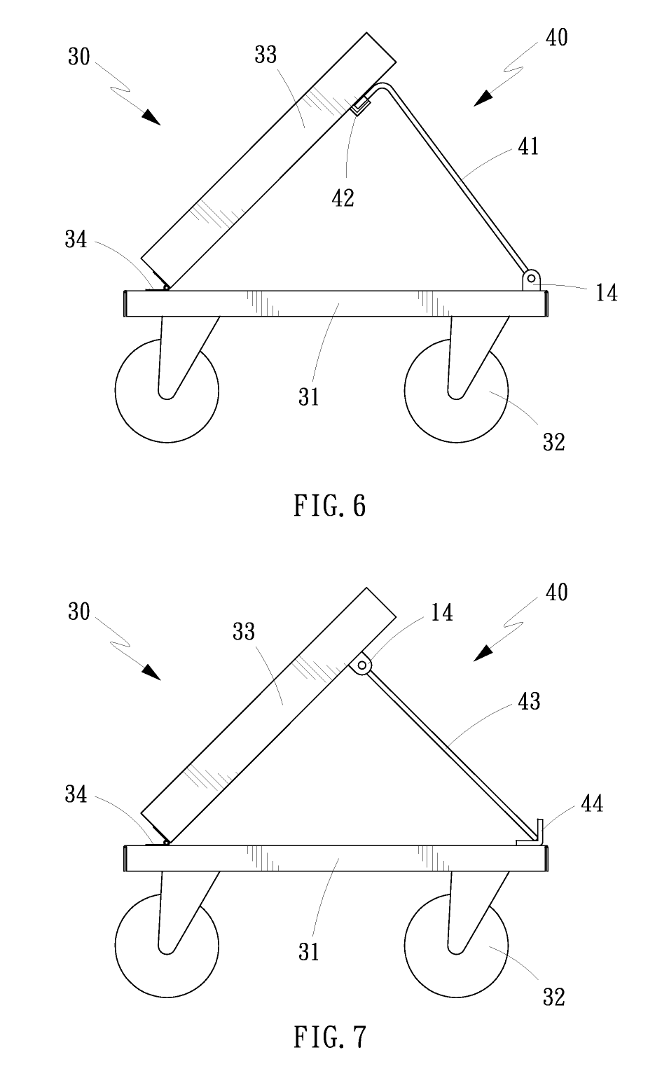

With reference to FIGS. 5 and 6, there is shown a tool-displaying apparatus 30 in accordance with a second embodiment of the present invention. The tool-displaying apparatus 30 includes a base 31, four casters 32, a tray 33, two hinges 34 and at least one linkage 40. The base 31 is simply a plate, not a frame consisting of four bars. The casters 32 are attached to the base 31 so that the tool-displaying apparatus 30 can easily be moved on the ground or a floor E. The tray 33 is pivotally connected to the base 31 by the hinges 34. The linkage 40 includes a brace 14, a lever 41 and a receptacle 42. The first section of the brace 14 is secured to the base 31 by screws, pins or rivets for example. The lever 41 is shaped like a hook. That is, the lever 41 is a bent metal strip that includes a first section extending perpendicular to a second section. The first section of the lever 41 is pivotally connected to the second section of the bracket 14 by a screw, pin or rivet for example. The receptacle 42 is secured to the tray 33 by screws, pin or rivets for example. The second section of the lever 41 is inserted in the receptacle 42 so that the tray 33 is kept raised relative to the base 31. The second section of the lever 41 can be removed from the receptacle 42 so that the tray 33 can be lowered relative to the base 31.

With reference to FIG. 7, there is shown a tool-displaying apparatus 30 in accordance with a third embodiment of the present invention. The third embodiment is identical to the second embodiment except for three things. At first, a lever 43 is used instead of the lever 41. The lever 43 is a rectilinear metal strip with two ends. Secondly, the bracket 14 is secured to the tray 33 instead of secured to the base 31. Thirdly, a stop 44 is secured to the base 31 instead of the bracket 14. The first end of the lever 43 is pivotally connected to the bracket 14. The second end of the lever 43 can be abutted against the stop 44 so that the tray 33 is kept raised as shown in FIG. 7.

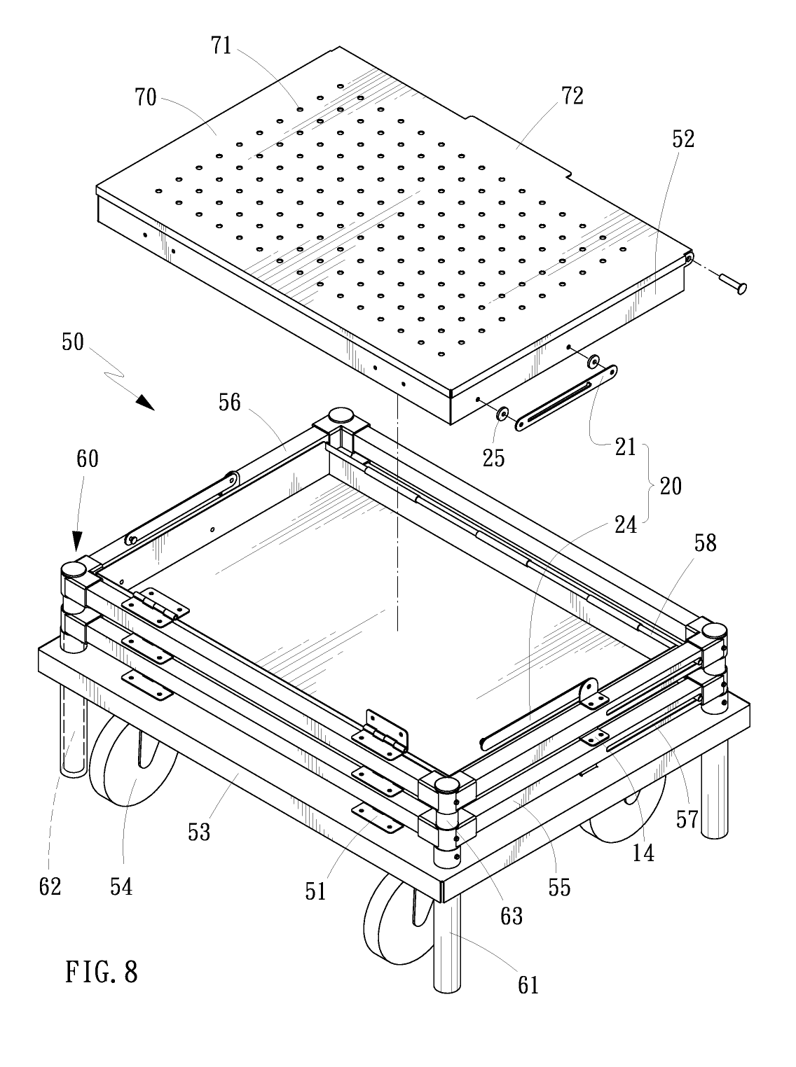

With reference to FIGS. 8 through 15, there is shown a tool-displaying apparatus 50 in accordance with a fourth embodiment of the present invention. The tool-displaying apparatus 50 includes three layers, four casters 54, four telescopic posts 60 and a cover 70.

The lower layer includes a lower base 53, a lower tray 52 and two lower-layer linkages 20. The lower base 53 is identical to the base 31. The lower tray 52 is identical to the tray 12. A sliding element 58 is secured to each of the left and right edges of the lower tray 52. The sliding elements 58 are like the sliding element of each of the linkages 20. The lower tray 52 is pivotally connected to the lower base 53 by two hinges 51. The lower-layer linkages 20 are provided between the lower tray 52 and the lower base 53.

The middle layer includes a middle base 55, a middle tray 52 and two middle-layer linkages 20. The middle base 55 is identical to the base 11 except including a slot 57 longitudinally defined in each of the left and right bars thereof near a rear end and an aperture 59 defined in each of four corners thereof. The middle tray 52 is pivotally connected to the middle base 55 by two hinges 51. The middle-layer linkages 20 are provided between the middle tray 52 and the middle base 55.

The upper layer includes an upper base 56, an upper tray 52 and two upper-layer linkages 20. The upper base 56 is identical to the middle base 55. The upper tray 52 is pivotally connected to the upper base 56 by two hinges 51. No sliding element 58 is secured to the upper tray 52. The upper-layer linkages 20 are provided between the upper tray 52 and the upper base 55.

In assembly, the casters 54 are attached to the lower base 53 so that the tool-display apparatus 50 can easily be moved on the ground or floor E. The body of each of the sliding elements 58 of the lower layer is movably inserted in the slot 57 of a related one of the left and right bars of the middle base 55 so that the lower layer is connected to the middle layer. Accordingly, the lower tray 52 is raised or lowered as the middle base 55 is raised or lowered. The body of each of the sliding elements 58 of the middle layer is movably inserted in the slot 57 of a related one of the left and right bars of the upper base 56 so that the middle layer is connected to the upper layer. Accordingly, the middle tray 52 is raised or lowered as the upper base 56 is raised or lowered.

Each of the telescopic posts 60 includes three tubes 61, 62 and 63 telescopically connected to one another. An external diameter of the middle tube 62 is marginally smaller than an internal diameter of the lower tube 61 so that the middle tube 62 can partially be inserted in the lower tube 61. An external diameter of the upper tube 63 is marginally smaller than an internal diameter of the middle tube 62 so that the upper tube 63 can partially be inserted in the middle tube 62.

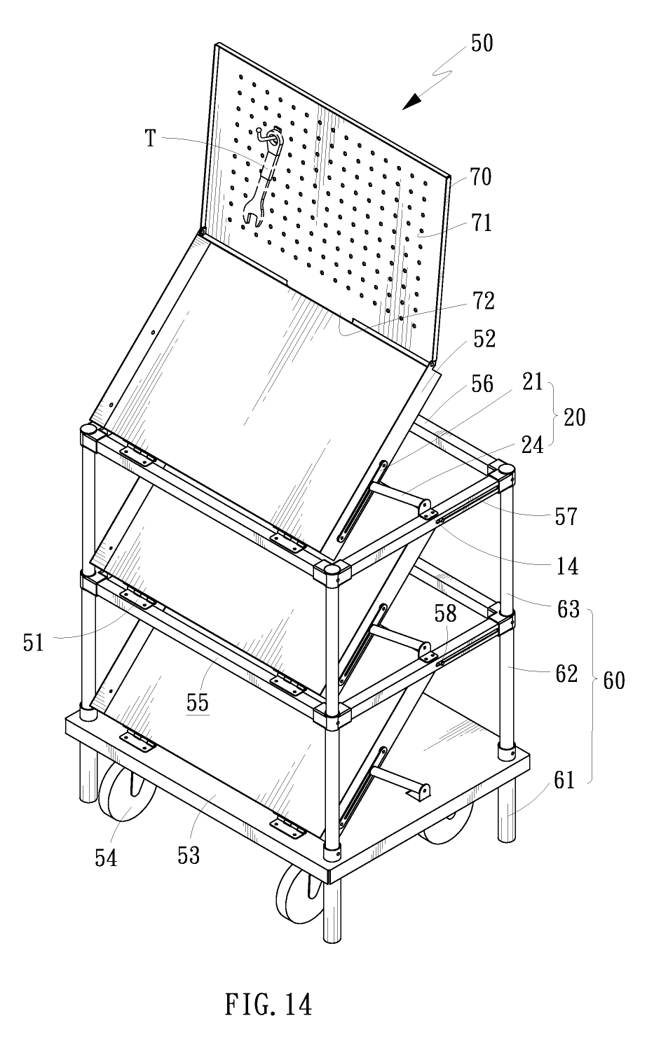

The lower tube 61 is connected to the lower base 53. The middle tube 62 is connected to the middle base 55. The upper tube 63 is connected to the upper base 56. Thus, the tool-displaying apparatus 50 can be moved between the positions shown in FIGS. 8 and 14 as the telescopic posts 60 are extended or shrunk.

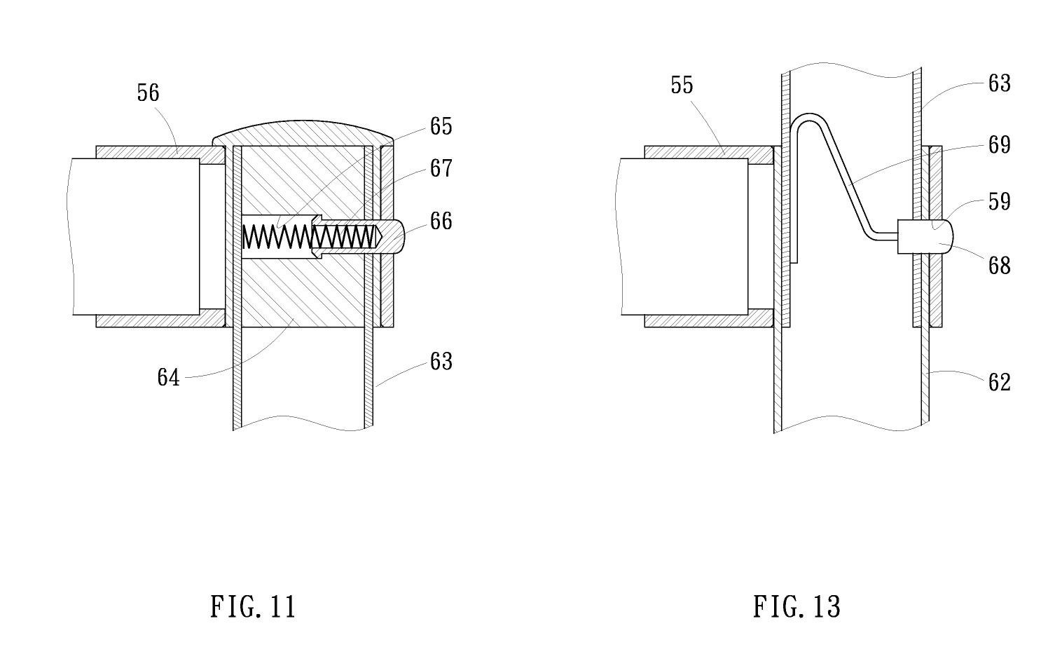

With reference to FIG. 11, an upper spring-biased detent unit is provided in an upper section of the upper tube 63. The upper spring-biased detent unit includes a plug 64, an upper detent 66 and an upper spring 67.

The plug 64 includes a stepped tunnel 65 transversely defined therein. The stepped tunnel 65 includes a thick section and a thin section so that an annular shoulder is formed between the thick and thin sections. The plug 64 is fit in the upper section of the upper tube 63.

The upper detent 66 includes a rounded tip formed at an end and an annular rib formed at an opposite end. The upper detent 66 is movably inserted in the thin section of the stepped tunnel 65. Now, the rounded tip of the upper detent 66 is located outside the upper base 56 through an aperture defined in the upper section of upper tube 63 and an aperture defined in the upper base 56. The annular rib of the upper detent 66 is located against the annular shoulder of the stepped tunnel 65 so that upper detent 66 is retained in the stepped tunnel 65. The upper detent 66 may be hollow for receiving a section of the upper spring 67.

The upper spring 67 is a compression spring and, more particularly, a helical spring. The upper spring 67 includes an end in contact with the upper detent 66 and an opposite end in contact with the upper section of the upper tube 63. Thus, the upper spring 67 biases the upper detent 66 and tends to keep the rounded tip of the upper detent 66 outside the upper base 56, thus positioning the upper base 56 relative to the upper tube 63.

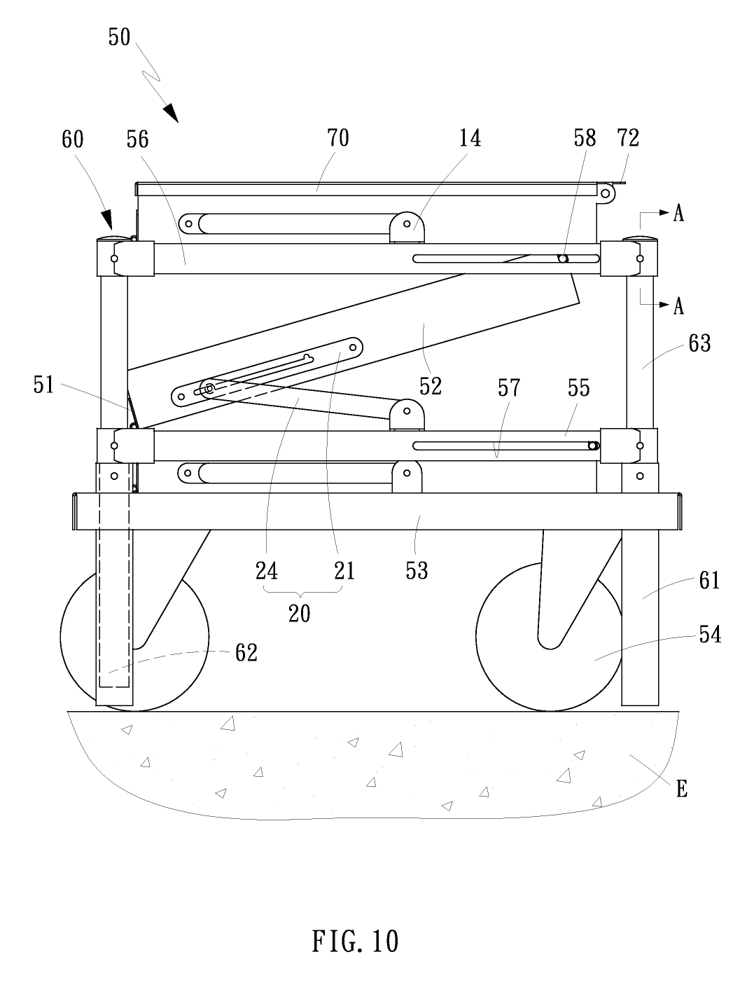

With reference to FIG. 10, the upper base 56 is lifted. The upper tray 52 is lifted together with the upper base 56 but not pivoted from the upper base 56. The upper tubes 63 are extended from the middle tubes 62 because of the upper spring-biased detent units operated as described above with reference to FIG. 11. The middle tray 52 is pivoted from the middle base 55 as the sliding elements 58 of the middle tray 52 slide in the slots 57 of the upper base 56.

With reference to FIG. 13, a lower spring-biased detent unit is provided in a lower section of the upper tube 63. The lower spring-biased detent unit includes a lower detent 68 and a lower spring 69.

The lower detent 68 includes a rounded tip formed at an end. The lower detent 68 is movably inserted in an aperture defined in a lower section of the upper tube 63, an aperture defined in an upper section of the middle tube 62 and a related one of the apertures 59 defined in the middle base 55. Now, the rounded tip of the lower detent 68 is located outside the middle base 55 via the aperture defined in the lower section of the upper tube 63, the aperture defined in the upper section of the middle tube 62 and the related aperture 59.

The lower spring 69 is a bent leaf spring with an end connected to the lower detent 68 and another end attached to the lower section of the upper tube 63. Thus, the lower spring 69 biases the lower detent 68 and tends to keep the rounded tip of the lower detent 68 outside the middle base 55, thus positioning the middle base 55 relative to the upper tube 63 and the middle tube 62.

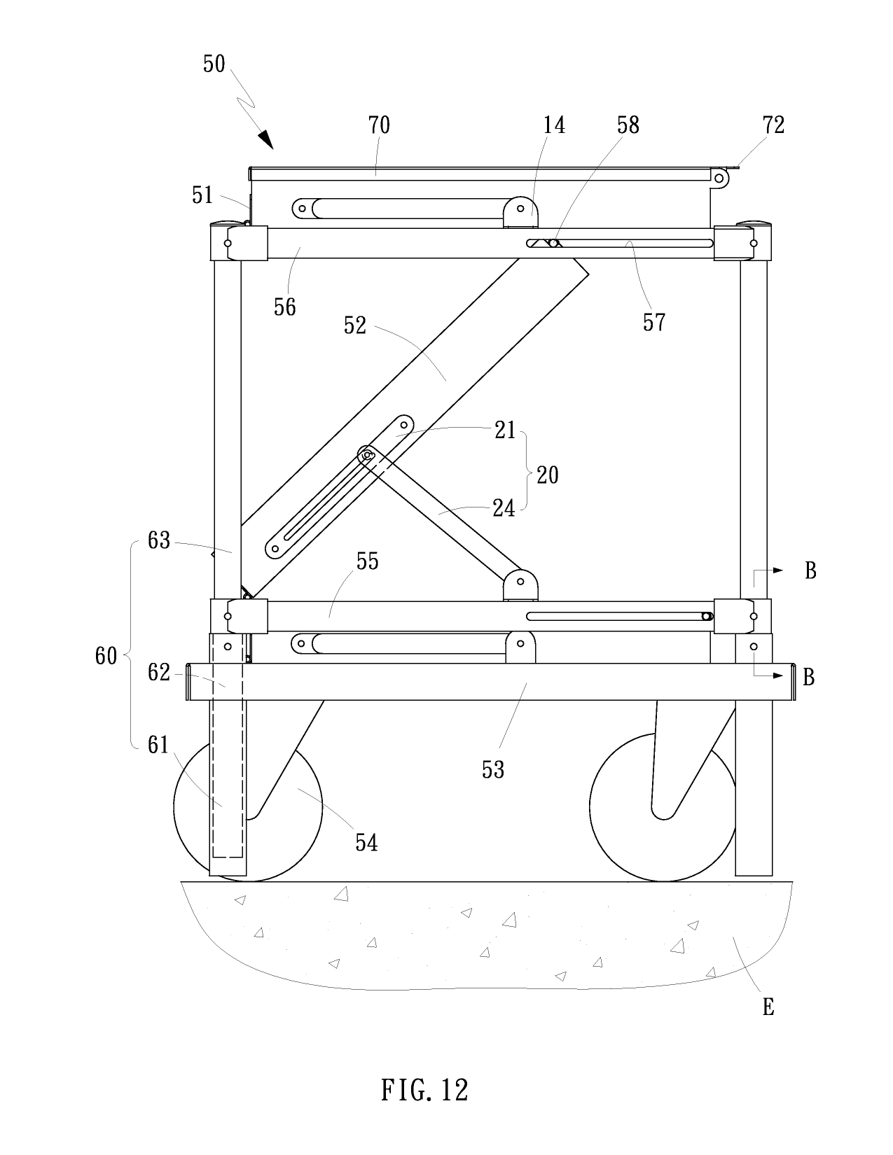

With reference to FIG. 12, the upper base 56 is lifted to a limit. Accordingly, the middle tray 52 is pivoted from the middle base 55 to a limit. Hence, the middle base 55 is lifted to a limit. The middle base 55 is retained in this position because of the lower spring-biased detent unit operated as described above with reference to the FIG. 13.

Although not shown, another spring-biased detent unit like the lower spring-biased detent unit is provided in the lower section of the middle tube 62 for positioning the middle tube 62 relative to the lower tube 61.

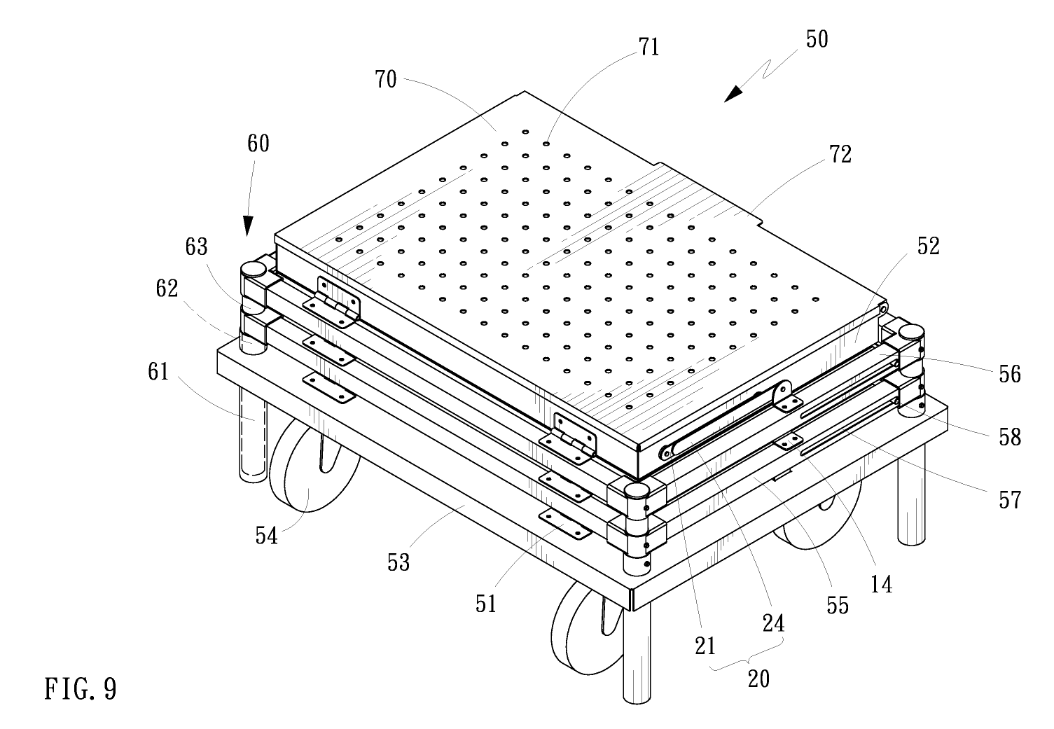

The cover 70 includes an array of apertures 71 defined therein and a tab 72 extending from an edge thereof. The cover 70 is pivotally connected to the upper tray 52. The cover 70 can be pivoted relative to the upper tray 52 between the positions shown in FIGS. 9 and 14. The tab 72 is located against an edge of the upper tray 52 when cover 70 is pivoted from the upper tray 52 to a limit. Thus, the cover 70 is positioned relative to the upper tray 52. A tool T can be hung on a hanger partially inserted in one of the aperture 71.

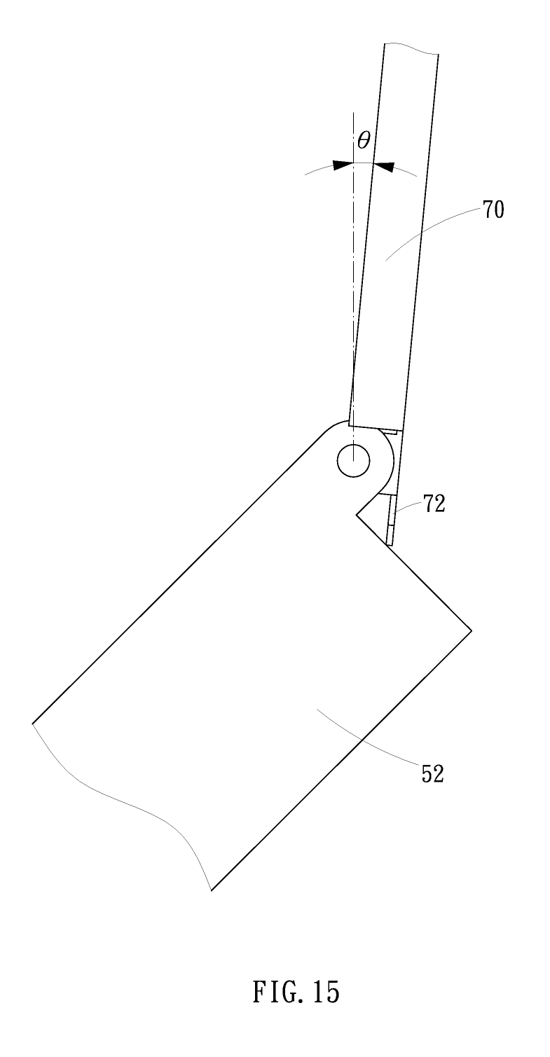

With reference to FIG. 15, the cover 70 is pivoted backward from the upper tray 52 beyond a vertical line extending the axis of the pivotal connection of the cover 70 to the upper tray 52. An angle θ is defined between a face of the cover 70 and the vertical line. The angle θ is 1 to 20 degrees. Thus, the weight of the tool T would result in a torque that tends to pivot the cover 70 backward from the upper tray 52. Accordingly, the cover 70 cannot be pivoted forward to the upper tray 52.

The tool-displaying apparatus includes only one middle layer in accordance with the fourth embodiment. However, the tool-displaying apparatus may include two middle layers or more in accordance with another embodiment.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A tool-displaying apparatus including:
a base;
a tray connected to the base so that they tray can be pivoted between a flat position and a fully pivoted relative to the base; and
at least one linkage for retaining the tray in the fully pivoted position relative to the base.

2. The tool-displaying apparatus in accordance with claim 1, further including at least one hinge for pivotally connecting the tray to the base.

3. The tool-displaying apparatus in accordance with claim 1, wherein the base is a frame.

4. The tool-displaying apparatus in accordance with claim 1, wherein the base is a plate.

5. The tool-displaying apparatus in accordance with claim 4, further including casters attached to the base.

6. The tool-displaying apparatus in accordance with claim 1, wherein the linkage includes:
a first lever secured to the tray; and
a second lever formed with a first end pivotally connected to the base and a second end movably connected to the first lever.

7. The tool-displaying apparatus in accordance with claim 6, wherein the linkage further includes a sliding element, wherein the first lever includes a slot for movably receiving the sliding element.

8. The tool-displaying apparatus in accordance with claim 7, wherein the first lever further includes a cutout defined in an edge of the slot, wherein the sliding element is retained in the cutout to keep the tray in the fully pivoted position.

9. The tool-displaying apparatus in accordance with claim 7, wherein the sliding element includes:
a body connected to the second lever and movably located in the slot; and
an enlarged head formed on the body for retaining the first lever connected to the second lever.

10. The tool-displaying apparatus in accordance with claim 4, wherein the linkage includes:
a receptacle attached to the tray; and
a lever including an end pivotally connected to the base and another end for insertion in the receptacle, thus retaining the tray in the fully pivoted position relative to the base.

11. The tool-displaying apparatus in accordance with claim 4, wherein the linkage includes:
a stop attached to the base; and
a lever including an end pivotally connected to the tray and another end for abutment against the stop, thus retaining the tray in the fully pivoted position relative to the base.

12. A tool-displaying apparatus including:
posts; and
at least two layers each including:
a base supported on the posts;
a tray connected to the base so that the tray can be pivoted between a flat position and a fully pivoted position relative to the base; and
a linkage for supporting the tray in a fully pivoted position relative to the base.

13. The tool-displaying apparatus in accordance with claim 12, wherein the base of the upper layer is movably supported on the posts.

14. The tool-displaying apparatus in accordance with claim 13, wherein the tray of the lower layer is movably and pivotally connected to the base of the upper layer.

15. The tool-displaying apparatus in accordance with claim 14, further including two sliding elements attached to the tray of the lower layer, wherein the base of the upper layer includes two slots for movably receiving the sliding elements.

16. The tool-displaying apparatus in accordance with claim 13, wherein the posts are telescopic posts.

17. The tool-displaying apparatus in accordance with claim 16, each of the posts includes a spring-biased detent unit located therein for retaining the post in a fully extended position.
